(19) United States
(12) Patent Application Publication
(10) Pub. No.: US 2011/0141025 A1
(43) Pub. Date: Jun. 16, 2011

(54) METHOD FOR OPERATING MOBILE DEVICE AND TOUCH-CONTROLLED MOBILE DEVICE

(75) Inventor: SHU-FENG TSAI, Taipei County (TW)

(73) Assignees: INVENTEC APPLIANCES (SHANGHAI) CO. LTD., Shanghai (CN); INVENTEC APPLIANCES CORP., Taipei County (TW)

(21) Appl. No.: 12/963,189

(22) Filed: Dec. 8, 2010

(30) Foreign Application Priority Data
Dec. 10, 2009 (CN) 200910252100.2

(51) Int. Cl. G06F 3/048; G06F 3/02; G06F 3/041

(52) U.S. Cl. 345/168; 715/835; 345/173

(57) ABSTRACT

The present invention discloses a method for operating a mobile device. The mobile device includes a keyboard and a display module. The keyboard includes a touch sensor and a control module connected to the touch sensor and the display module. The display module is used for displaying a round display area. The round display area has predetermined icons disposed in a circular arrangement in the round display area. The method comprises the steps of: touching the keyboard to perform a slide on the keyboard; the touch sensor detecting the slide on the keyboard for generating movement information according to the slide; and the control module enabling selecting one of the icons in the round display area according to the movement information.

### BACKGROUND OF THE INVENTION

1. Field of the Invention

The present invention relates to a mobile device, and more particularly to a method for operating a mobile device with a round display area that is convenient to operate for a user.

2. Description of Related Art

In recent years, intellectual mobile devices have substantial developments in the market of open mobile device platforms. Users of the intellectual mobile devices were purely businessmen and are extended to general users, since the instinct, user-friendly, and touch-controlled oriented user interface have improved the original user-unfriendly user interface. The intellectual mobile devices constantly improve visual effects (such as a 3D dynamic effect) and provide consumers more amazing using experiences.

The intellectual mobile device with a simple instinctive touch-controlled interface has become a popular product in the market, and thus major intellectual mobile device manufacturers started to imitate that and developed innovative touch-controlled user interface for their brands.

In Taiwan Pat. No. M315457, a mobile device keyboard is disclosed, and this patent is characterized in that two functions of pressing and touch sliding are integrated into the keyboard for providing a simple and easy operation to users. However, this patent has not integrated the method for operating the intellectual mobile device with the touch-controlled keyboard yet.

### SUMMARY OF THE INVENTION

An object of the present invention is to provide a method for operating a mobile device.

An aspect of the present invention provides a method for operating a mobile device including a keyboard and a display module. The keyboard includes a touch sensor and a control module connected to the touch sensor and the display module. The display module is used for displaying a round display area, and the round display area has predetermined icons disposed in a circular arrangement in the round display area. The method for operating a mobile device includes the steps of: touching the keyboard to perform a slide on the keyboard; the touch sensor detecting the slide on the keyboard for generating movement information according to the slide; and the control module enabling selecting one of the icons in the round display area according to the movement information.

Another aspect of the present invention provides a method for operating a mobile device including a display module for displaying a round display area. The display module includes a touch sensor and a control module connected to the touch sensor. The round display area has predetermined icons disposed in a circular arrangement in the round display area. And the method for operating the mobile device includes the steps of: touching the display module to perform a slide on the display module; the touch sensor detecting the slide on the display module for generating movement information according to the slide; and the control module enabling selecting one of the icons according to the movement information.

Another object of the present invention is to provide a touch-controlled mobile device.

An aspect of the present invention provides a touch-controlled mobile device including a display module for displaying a round display area, a touch sensor, and a control module connected to the touch sensor and the display module. The touch-controlled mobile device may also include a keyboard which includes the touch sensor. With respect to the display module, the round display area has icons disposed in an outer circular area of the round display area and a selection area in the outer circular area. If the touch sensor detects a slide on the touch-controlled mobile device to generate movement information according to the slide, the control module enables selecting one of the icons, by moving the selection area to correspond with the selected one of the icons according to the movement information.

Therefore, the present invention provides a touch-controlled mobile device capable of displaying a round display area, and a method for operating such a mobile device. Users can control the round display area on a screen of the mobile device by the keyboard or screen of the touch-controlled mobile device to make the round display area rotate to a user's predetermined position, thereby entering into another function model or operation interface. The method has instinct, user-friendly characteristics that allow users more convenient operations. Moreover, this method integrates the touch-controlled keyboard and the screen into the method for operating a mobile device.

The advantages and spirit of the present invention can be further understood by referring to the following detailed description of the invention and the accompanying drawings.

### BRIEF DESCRIPTION OF THE DRAWINGS

FIG. 1 shows a flow chart of a method for operating a mobile device in accordance with an embodiment of the present invention;

FIG. 2 shows a schematic diagram of a touch-controlled mobile device in accordance with an embodiment of the present invention;

FIG. 3 shows a flow chart of a method for operating a mobile device in accordance with another embodiment of the present invention; and

FIG. 4 shows a schematic diagram of a touch-controlled mobile device in accordance with another embodiment of the present invention.

### DETAILED DESCRIPTION OF THE PREFERRED EMBODIMENTS

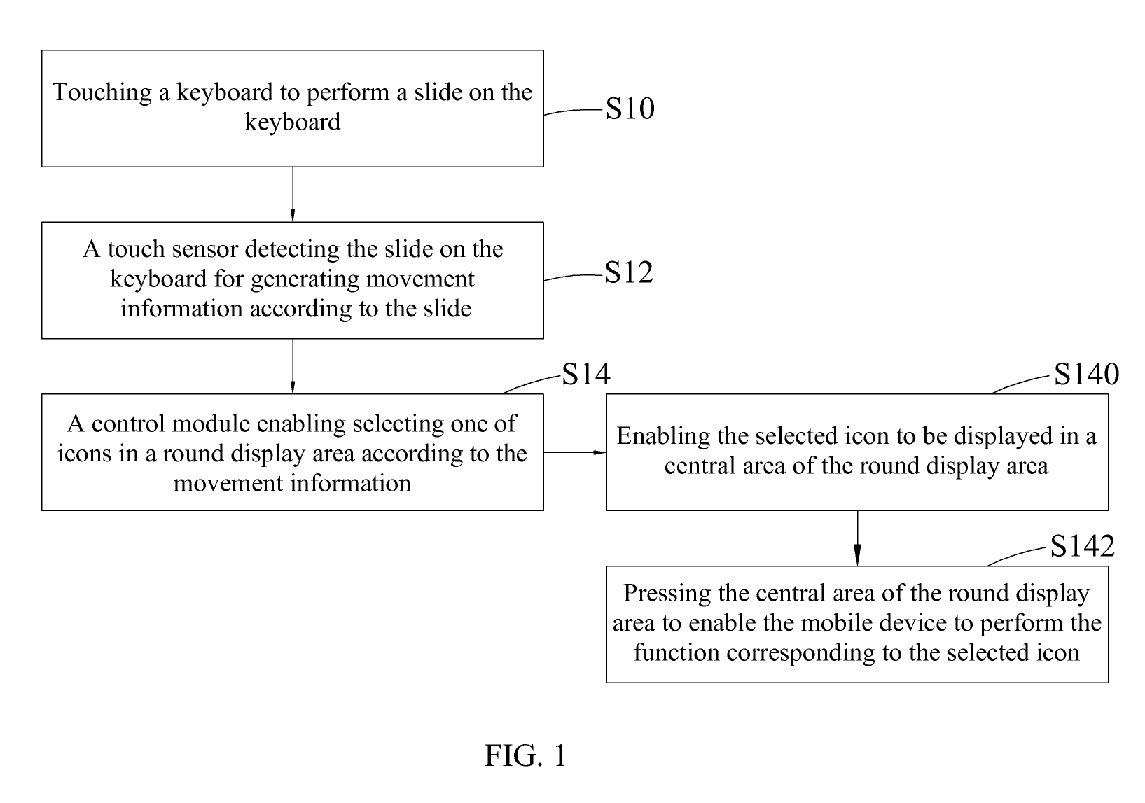

The present invention provides a method for operating a mobile device including a keyboard and a display module. FIG. 1 shows a flow chart of the method for operating a mobile device in accordance with an embodiment of the present invention. In this embodiment, the mobile device includes a keyboard and a display module. The keyboard includes a touch sensor, and a control module connected to the touch sensor and the display module.

The above-mentioned display module is used for displaying a round display area, which has predetermined icons disposed in a circular arrangement in the round display area. It may be that the display module displays the round display area. Also, the word “round” in “round display area” is used herein as a generic term to encompass the case of a roundish or circular display area, and the predetermined icons may be default icons set by the mobile device or may be set by a user.

As shown in FIG. 1, according to this embodiment, the method has the following steps to be performed. Step S10 is touching, for example by the user, the keyboard of the mobile device to perform a slide on the keyboard. Then step S12 is the touch sensor detecting the slide on the keyboard for generating movement information according to the slide. An embodiment may be that the touch sensor detects the slide on the keyboard and then generates the movement information. Then step S14 is the control module enabling selecting one of the icons in the round display area according to the movement information.

Further, the step S14 may include a step of enabling, for example by the control module, the mobile device to perform a function corresponding to a selected one of the icons. The function may in practice be, but is not limited to, opening or activating an operating interface of the mobile device. For example, the operating interface may be used for managing contact person information.

In practical applications, the icons may be composed of, but are not limited to, a portrait icon, a house icon, a music note icon, a camera icon, a mail icon, a ring icon, and a tool icon. Furthermore, the above-mentioned icons each may correspond to functions or operating interfaces of contact person information, a mobile device homepage, a mobile device ringtone, image photography and video recording, a message and mail, an alarm, and a mobile device setting, respectively.

In practical operations, the user touches the keyboard to perform a slide on the keyboard, which slide may be, but is not limited to, a slide towards the left or right, a clockwise slide, or a counter-clockwise slide. The touch sensor of the mobile device detects the slide on the keyboard and then generates corresponding movement information according to the slide. The control module of the mobile device enables the round display area to clockwise or counter-clockwise rotate and further selects one of the icons (hereinafter the selected icon is called as first icon) in the round display area according to the movement information; or the control module enables a special selection area in the round display area to clockwise or counter-clockwise rotate and further selects the first icon of the icons. Wherein, the icon may be one of the portrait icon, house icon, music note icon, camera icon, mail icon, ring icon, and tool icon.

In addition, referring to FIG. 1, the method can perform step S140 of enabling the selected one of the icons to be displayed in a central area of the round display area at the same time while performing the step S14. When the selected icon is displayed in the central area of the round display area, it may be performed in step S142 that the user presses the central area of the round display area to enable the mobile device to perform the function corresponding to the selected icon. Please note that in practice, according to the design of different kinds of the mobile devices, the user can also press a key corresponding to the central area of the round display area to perform the function corresponding to the first icon.

For example, if the first icon selected by the user is the portrait icon, the portrait icon will be simultaneously displayed in the central area of the round display area. Wherein, the function corresponding to the portrait icon may be to display an operating interface used for managing contact person information. When the user presses the portrait icon in the central area of the round display area or the key corresponding to the central area of the round display area, the mobile device immediately performs to display the operating interface about the contact person information. Similarly, if the first icon selected by the user is the house icon, the house icon will be simultaneously displayed in the central area of the round display area. Wherein, the function corresponding to the house icon is to display an operating interface of a mobile device homepage. When the user presses the house icon in the central area of the round display area or the key corresponding to the central area of the round display area, the mobile device immediately performs to display the operating interface of the mobile device homepage.

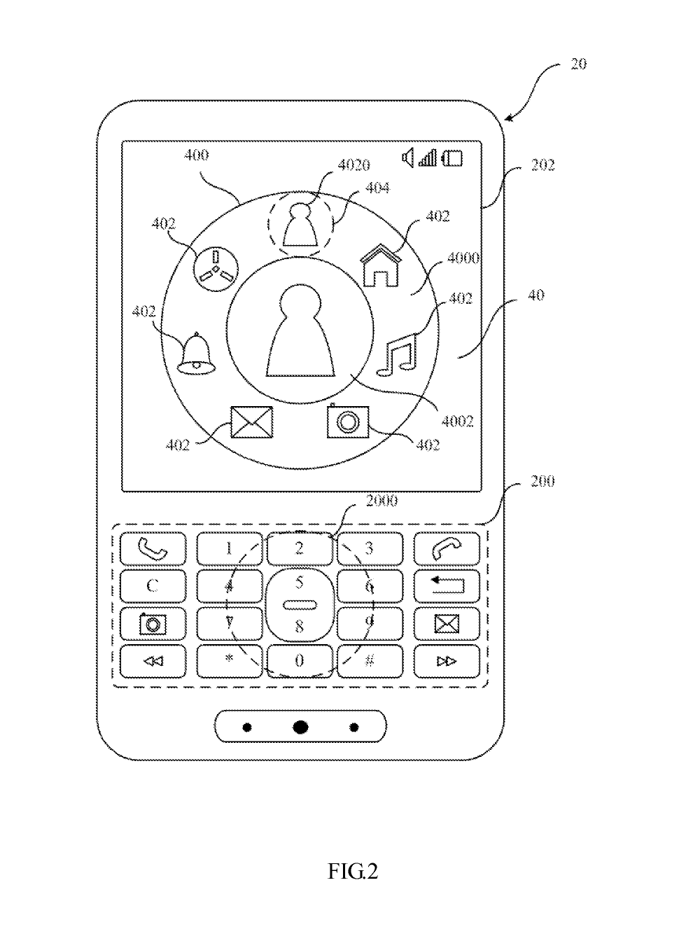

An aspect of the present invention provides a touch-controlled mobile device. FIG. 2 shows a schematic diagram of a touch-controlled mobile device in accordance with an embodiment of the present invention. Referring to FIG. 2, the touch-controlled mobile device 20 includes a keyboard 200 and a display module 202. The keyboard 200 includes a touch sensor 2000 and a control module (not shown in figure, but in practice may be capable of being disposed inside a casing of the touch-controlled mobile device) connected to the touch sensor 2000 and the display module 202.

As shown in FIG. 2, the display module 202 can display an operating interface 40 having a round display area 400. The round display area 400 includes icons 402 and a selection area 404. The icons 402 are disposed in an outer circular area 4000 of the round display area 400. The selection area 404 is disposed in the outer circular area 4000. Wherein, the icons 402 may be default icons set by the touch-controlled mobile device 20 or may be set by a user. Please note that in practice, the selection area 404 can be directly displayed in the display module 202 to be observed by the user. For instance, the selection area 404 may be a frame icon with a moderate size. Alternatively, the selection area 404 may not be directly displayed in the display module 202, and the icon 402 selected by the selection area 404 (i.e. first icon 4020) generates a visual effect unlike other icons 402 such that the user can recognize the first icon 4020. For example, the first icon 4020 can generates the visual effect of being enlarged, twinkled, or simultaneously displayed in a central area of the round display area 400.

In practical applications, the icons may be composed of, but are not limited to, a portrait icon, a house icon, a music note icon, a camera icon, a mail icon, a ring icon, and a tool icon. Moreover, the above-mentioned icons each may correspond to functions or operating interfaces of contact person information, a mobile device homepage, a mobile device ringtone, image photography and video recording, a message and mail, an alarm, and a mobile device setting, respectively.

When or if the touch sensor 2000 detects a slide on the keyboard 200 to generate movement information according to the slide, the control module enables selecting one of the icons, for example the first icon 4020, by moving the selection area 404 to correspond with the selected icon, the first icon 4020, according to the movement information. The above condition may be that the touch sensor 2000 detects the slide and then generates the movement information according to the slide. In this embodiment, the first icon 4020 corresponds to a first function, and the first function may be to open or activate an operating interface of the mobile device. Please note that in this embodiment, the touch sensor 2000 is located below the key of the keyboard 200. Therefore, in practice, a switch can be designed for switching the touch sensor 2000 and the key in order to avoid inadvertently touching other keys in a touch control process.

The above-mentioned round display area 400 further comprises a central area 4002 for displaying the first icon 4020 at the same time. For example, if the first icon 4020 selected by the user is the portrait icon, the portrait icon will be simultaneously displayed in the central area 4002 of the round display area 400. If the first icon 4020 selected by the user is the house icon, the house icon will be simultaneously displayed in the central area 4002 of the round display area 400.

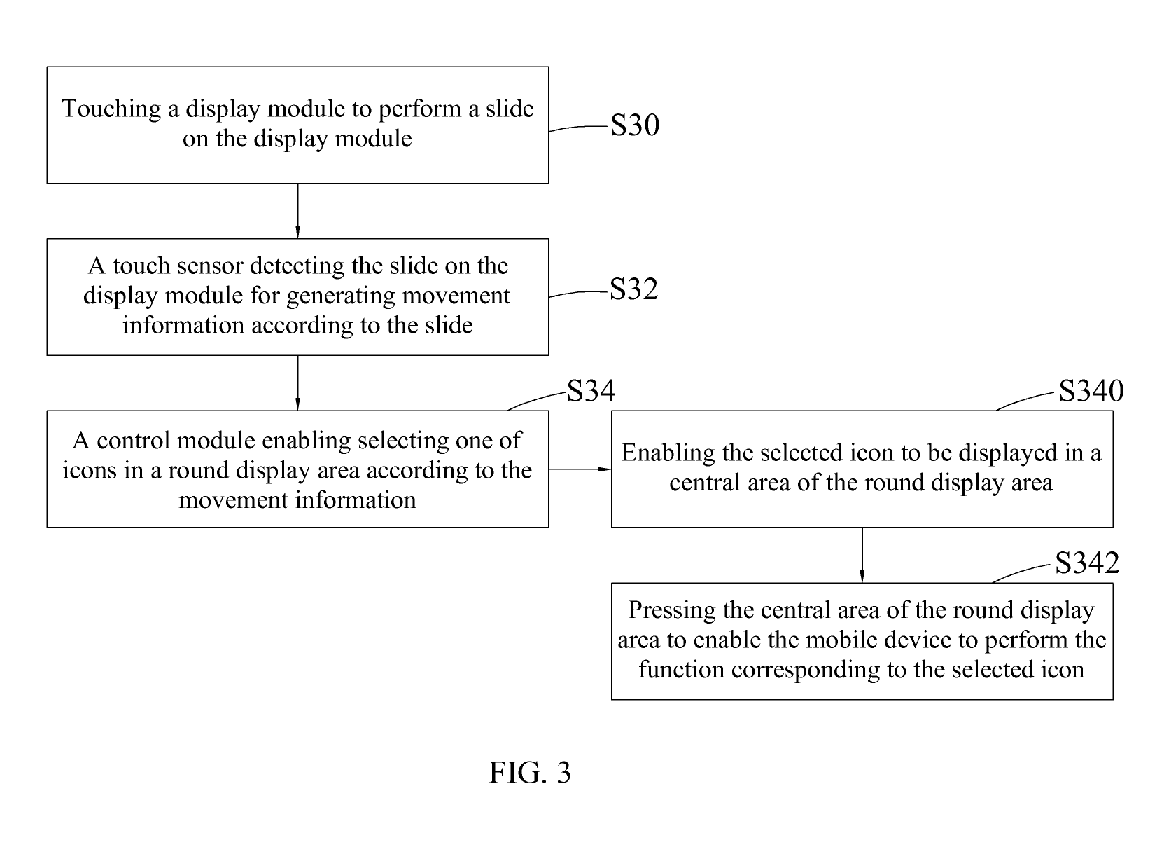

Another aspect of the present invention is to provide a method for operating a mobile device including a display module for displaying a round display area. FIG. 3 shows a flow chart of the method for operating a mobile device in accordance with another embodiment of the present invention. The mobile device may include a display module. The display module includes a touch sensor and a control module connected to the touch sensor.

The above-mentioned display module is used for displaying a round display area. The round display area may have predetermined icons disposed in a circular arrangement in the round display area. Wherein, the icons may be default icons set by the mobile device or may be set by a user.

Referring to FIG. 3, according to this embodiment of the present invention, the method has the following steps to be performed. Step S30 is touching, for example by the user, the display module to perform a slide on the display module. Then step S32 is the touch sensor detecting the slide on the display module for generating movement information according to the slide. An embodiment may be that the touch sensor detects the slide on the display module and then generates the movement information. Then step S34 is the control module enabling selecting one of the icons in the round display area according to the movement information.

Further, the step S14 may include a step of the control module enabling the mobile device to perform a function corresponding to a selected one of the icons. Wherein, the function may be to open or activate a corresponding operating interface.

In practical applications, the icons may be composed of, but are not limited to, a portrait icon, a house icon, a music note icon, a camera icon, a mail icon, a ring icon, and a tool icon. Furthermore, the above-mentioned icons each may correspond to functions or operating interfaces of contact person information, a mobile device homepage, a mobile device ringtone, image photography and video recording, a message and mail, an alarm, and a mobile device setting, respectively.

Furthermore, as shown in FIG. 3, the method may further perform step S340 of enabling the selected one of the icons to be displayed in a central area of the round display area. When the selected icon is displayed in the central area of the round display area, it may be performed in step S342 that the user presses the central area of the round display area to enable the mobile device to perform a function corresponding to the selected icon. Wherein, the function may be to open or activate a corresponding operating interface.

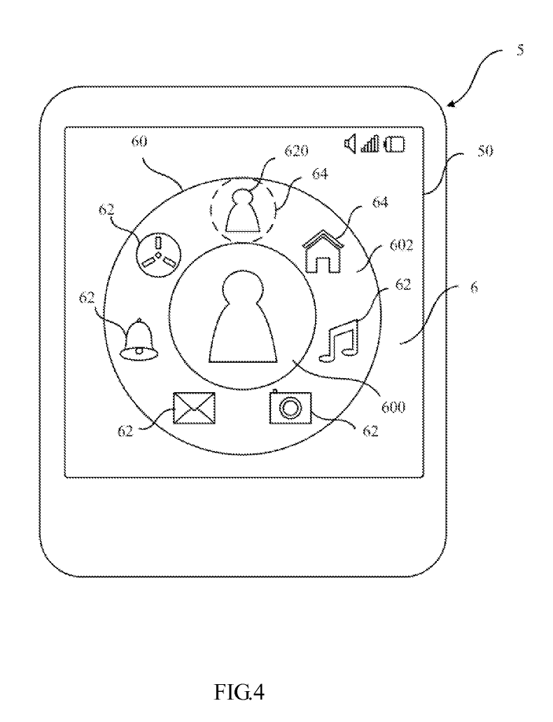

Another embodiment of the touch-controlled mobile device provided by the invention is described as follows. FIG. 4 shows a schematic diagram of a touch-controlled mobile device 5 in accordance with another embodiment of the present invention. Referring to FIG. 4, the touch-controlled mobile device 5 includes a display module 50, and the display module 50 is a touch-controlled display module. In practice, the display module 50 can include a touch sensor and a control module (not shown) connected to the touch sensor. The display module 50 is used for displaying an operating interface 6 including a round display area 60. The round display area 60 includes icons 62 disposed in an outer circular area 602 of the round display area 60, and a selection area 64 in the outer circular area 602. In this embodiment, the relationship between the various elements is mainly the same as the above-mentioned embodiment and is not described again.

When or if the touch sensor of the display module 50 detects a slide on the touch-controlled mobile device 5 to generate movement information according to the slide, the control module enables selecting one of the icons, for example the first icon 620, by moving the selection area 64 to correspond with the selected icon, the first icon 620 of the icons 62, according to the movement information. The above condition may be that the touch sensor detects the slide and then generates the movement information according to the slide. In this embodiment, the icons 62 may be default icons set by the touch-controlled mobile device 5 or may be set by a user. The first icon 620 each has a corresponding function, and the function may be, but is not limited to, opening or activating an operating interface of the mobile device. Besides, the above-mentioned round display area 60 further comprises a central area 600 for displaying the first icon 620 at the same time. The user can directly touch the central area 600 of the display module 50 for enabling the touch-controlled mobile device 5 to perform the corresponding function.

In summary, the method for operating a mobile device in accordance with the present invention provides the operating interface including the round display area as the operating interface of the touch-controlled mobile device. The user can control the round display area on a screen of the mobile device by the keyboard of the touch-controlled mobile device to make it rotate to a user's predetermined position, thereby entering into another function model or operation interface. The method has instinct, user-friendly characteristics that allow users more convenient operations. In addition, this method integrates the touch-controlled keyboard into the method for operating a mobile device.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiments of the present invention.

What is claimed is:

1. A method for operating a mobile device, the mobile device including a keyboard and a display module, the keyboard including a touch sensor and a control module connected to the touch sensor and the display module, the display module being used for displaying a round display area, the round display area having predetermined icons disposed in a circular arrangement in the round display area, the method comprising the steps of:
touching the keyboard to perform a slide on the keyboard;
the touch sensor detecting the slide on the keyboard for generating movement information according to the slide; and
the control module enabling selecting one of the icons in the round display area according to the movement information.

2. The method of claim 1, wherein the icons are default icons set by the mobile device or set by a user.

3. The method of claim 1, wherein the step of the control module enabling selecting one of the icons further comprises the step of:
enabling the mobile device to perform a function corresponding to a selected one of the icons.

4. The method of claim 3, wherein the function is to open or activate an operating interface.

5. The method of claim 1, wherein the step of the control module enabling selecting one of the icons further comprises the step of:
enabling a selected one of the icons to be displayed in a central area of the round display area.

6. The method of claim 5, further comprising the step of:
pressing the central area of the round display area to enable the mobile device to perform a function corresponding to the selected icon, when the selected icon is displayed in the central area of the round display area.

7. A touch-controlled mobile device, including:
a display module for displaying a round display area, the round display area having:
icons disposed in an outer circular area of the round display area; and
a selection area in the outer circular area;
a touch sensor; and
a control module connected to the touch sensor and the display module;
wherein if the touch sensor detects a slide on the touch-controlled mobile device to generate movement information according to the slide, the control module enables selecting one of the icons, by moving the selection area to correspond with the selected one of the icons according to the movement information.

8. The touch-controlled mobile device of claim 7, wherein the icons are default icons set by the touch-controlled mobile device or set by a user.

9. The touch-controlled mobile device of claim 7, wherein a selected one of the icons corresponds to a function.

10. The touch-controlled mobile device of claim 9, wherein the function is to open or activate an operating interface.

11. The touch-controlled mobile device of claim 7, wherein the round display area further includes a central area for displaying a selected one of the icons.

12. The touch-controlled mobile device of claim 7, including a keyboard which includes the touch sensor.

13. A method for operating a mobile device, the mobile device including a display module for displaying a round display area, the display module including a touch sensor and a control module connected to the touch sensor, the round display area having predetermined icons disposed in a circular arrangement in the round display area, the method comprising the steps of:
touching the display module to perform a slide on the display module;
the touch sensor detecting the slide on the display module for generating movement information according to the slide; and
the control module enabling selecting one of the icons according to the movement information.

14. The method of claim 13, wherein the icons are default icons set by the mobile device or set by a user.

15. The method of claim 13, wherein the step of the control module enabling selecting one of the icons further comprises the step of: enabling the mobile device to perform a function corresponding to a selected one of the icons.

16. The method of claim 15, wherein the function is to open or activate an operating interface.

17. The method of claim 13, wherein the step of the control module enabling selecting one of the icons further comprises the step of:
enabling a selected one of the icons to be displayed in a central area of the round display area.

18. The method of claim 17, further comprising the step of:
pressing the central area of the round display area to enable the mobile device to perform a function corresponding to the selected icon, when the selected icon is displayed in the central area of the round display area.
